(19) United States
(12) Patent Application Publication
(10) Pub. No.: US 2023/0071155 A1
(43) Pub. Date: Mar. 9, 2023

(54) METHOD AND SYSTEM FOR MONITORING ENERGY FLOW OF HVAC SYSTEM

(71) Applicant: BELIMO HOLDING AG, Hinwil (CH)

(72) Inventors: Ralf KASTLE, Zurich (CH); Stefan MISCHLER, Wald (CH); Peter SCHMIDLIN, Uster (CH); Marc THUILLARD, Uetikon am See (CH)

(21) Appl. No.: 17/794,784

(22) PCT Filed: Jan. 22, 2021
(86) PCT No.: PCT/EP2021/051511

§ 371 Date: Jul. 22, 2022

(30) Foreign Application Priority Data
Jan. 24, 2020 (CH) 00085/20

(51) Int. Cl. F24F 11/46; G05B 19/042

(52) U.S. Cl. CPC F24F 11/46; G05B 19/042; F24F 2110/10

(57) ABSTRACT

The invention relates to method (600) for operating an HVAC system, the method comprising: obtaining (602) a plurality of directly measured parameters from one or more data sources; determining (604) one or more indirectly measured parameter based on one or more of the plurality of directly measured parameters; and monitoring (606) energy flow of the HVAC system, based on the plurality of directly measured parameters and the one or more indirectly measured parameters, wherein the energy flow corresponds to heat transfer between the heat transfer medium and the air. The invention further relates to a an apparatus for operating an HVAC system which comprises means of monitoring an energy flow, based on a plurality of directly measured parameters and one or more indirectly measured parameters.

### FIELD OF THE INVENTION

The present invention relates to a method, and a system for monitoring energy flow of heating, ventilation and air conditioning (HVAC) system, in which a heat exchanger is connected to a primary flow path with a supply line and a return line, wherein a heat transfer medium enters the heat exchanger through the supply line with an inlet temperature and exits the heat exchanger with an outlet temperature via the return line, and wherein the heat exchanger transmits a heat flow to air flowing through an air flow path, which enters the heat exchanger with a supply air temperature and a supply air humidity and which exits the heat exchanger with a conditioned air temperature and a conditioned air humidity. Specifically, the present invention relates to a method and a system for monitoring the energy flow of the HVAC system.

### BACKGROUND OF THE INVENTION

In heating, ventilating and air-conditioning (HVAC) systems, heat and/or cold is normally generated and supplied into buildings or at least certain rooms thereof. In HVAC systems, flow rates of fluids have to be monitored and adapted to current requirements. The requirements depend on parameters determining the demand for heating, ventilation and air conditioning within the building, such as outside temperature, humidity, solar radiation, as well as a number of people, machines and devices within the building, which may consume fresh air and emit energy. The heat flow emitted or absorbed by the heat exchanger, which is required for achieving a predetermined room temperature, is often controlled in such a manner that flow rate of the heat transfer medium, in the most cases water, flowing in the primary flow path is changed accordingly. Resetting suitable operating parameters of the HVAC system, such as chilled water temperature and supply air temperature may result in energy saving and efficient operation of the HVAC system.

With the increasing energetic performances of buildings, less energy is required in buildings. Consequently, the energy distribution through the air flow becomes a larger part of the building energy. There is, therefore, an increasing demand to combine the water and the air side in the energy optimization of an HVAC system. There is also an increasing need for systems monitoring and optimizing the energy flows (air, water, humidity and air quality). In multi-users buildings such as a supermarket, there is also a need for a system allowing the fair allocation of the energy costs including air distribution.

Currently, a plurality of sensors, in particular flow sensors, is needed. in such systems in order to monitor the suitable operating parameters of the HVAC system and modify the operating parameters according to current requirements. However, such arrangements of sensors, i.e. arrangement within the air ducts, pose as obstacles impairing flow characteristics. Further, flow resistance is increased and thus energy requirement for pumps or fans moving the fluid rises. Moreover, the sensors as well as the rods carrying them are prone to fouling. Residues like dust or dirt may build up on the rods and the sensors, which again impairs the flow characteristics. Consequently, measurement accuracy of the sensors may be decreased. To that end, installing, operating and maintaining such sensor arrangements produce costs with a negative economic effect for the entire HVAC installation.

Therefore, there is a need for a method and a system that provide efficient monitoring of the suitable operating parameters of the HVAC system without impairing the flow characteristics.

### SUMMARY OF THE INVENTION

In order to solve the foregoing problem, the present invention provides a method and a system for monitoring energy flow of an HVAC system with a reduced number of sensors. Further, it is also an objective of some embodiments to control actuators of the HVAC system, based on one or more energy flow requirements, to optimize the energy flow in the HVAC system.

According to the present invention, these objectives are achieved through the features of independent claims. In addition, further advantageous embodiments follow from the dependent claims and the description.

The method according to the present invention for operating the HVAC system, in which a heat exchanger is connected to a primary flow path with a supply line and a return line, wherein a heat transfer medium enters the heat exchanger through the supply line with an inlet temperature and exits the heat exchanger with an outlet temperature via the return line, and wherein the heat exchanger transmits a heat flow to air flowing through an air flow path, which enters the heat exchanger with a supply air temperature and a supply air humidity and which exits the heat exchanger with a conditioned air temperature and a conditioned air humidity, the method comprising: obtaining a plurality of directly measured parameters from one or more data sources; determining one or more indirectly measured parameter based on one or more of the plurality of directly measured parameters; and monitoring energy flow of the HVAC system, based on the plurality of directly measured parameters and the one or more indirectly measured parameters, wherein the energy flow corresponds to heat transfer between the heat transfer medium and the air.

In the context of present invention, the primary flow path is designated as waterside, though other fluids than water might be used as the heat transfer medium in the primary flow path. Likewise, the air flow path is designated as the airside, wherein a section downstream to the heat exchanger is referred to as conditioned air side. Further, in the context of the present invention, the energy flow which corresponds to heat transfer between the heat transfer medium and the air, encompassed heating and/or cooling of the air in the air flow path. In the context of this invention, an air flow path preferably includes an air duct. In other embodiments it may also include a closed room arranged between a first and a second air duct.

In a preferred embodiment, the one or more data sources comprise sensors disposed at the air flow path and at the primary flow path in the HVAC system, and wherein the sensors comprise a temperature sensor, a differential pressure sensor and/or a humidity sensor. In some embodiments, the plurality of directly measured parameters comprise temperature of air at the air side, humidity of air at the air side, temperature of inlet water at the water side, temperature of outlet water at the water side, and humidity of conditioned air. Further, in some embodiments, the one or more indirectly measured parameters correspond to one or more airflow rate of the air flowing through the air flow path or temperature of the conditioned air.

In a further preferred embodiment, one of the one or more of the indirectly measured parameters represents airflow rate of the air flowing through the air flow path. By indirectly determining respectively measuring the air flow rate, an air flow sensor within the air path can be avoided. Sensors in the air flow path pose as obstacles in the air flow path, impairing flow characteristics. Further, flow resistance is increased and thus energy requirement for fans moving the air rises. Moreover, the sensors as well as rods carrying them are prone to fouling. Residues like dust or dirt may build up on the rods and the sensors, which again impairs the flow characteristics. Consequently, measurement accuracy of the sensors may be decreased over time. To that end, installing, operating and maintaining such sensor arrangements produce costs with a negative economic effect for the entire HVAC installation.

In another preferred embodiment monitoring the energy flow of the HVAC system comprises estimating the heat transfer between the heat transfer medium and the air by means of the supply air temperature, the conditioned air temperature and the airflow rate of the air flowing through the air flow path. To that end, it may be realized that the energy respectively the heat transferred from the cooling coil to the air flow is estimated based on the directly measured parameters and the indirectly measured parameter. Namely, the transferred heat can be estimated without knowing temperature difference between the inlet and the outlet temperature of the heat transfer medium and in particular without knowing the flow rate of the heat transfer medium. In other words, the energy transferred from the cooling coil to the air flow is estimated and monitored with reduced number of sensors. Furthermore, as the number of sensors in the primary flow path is reduced, the impact of the sensors on the fluid lines of the primary flow path and/or flow characteristics of the fluid in the fluid lines of the primary flow path is reduced. Thereby, the method according to the present invention yields a decisive advantage over the current methods that at least one of the sensors for measuring operating parameters of the HVAC system can be omitted. Thus, the present invention enables reduction of the number of sensors, maintains desired flow characteristics within the ducts or any fluid lines, and helps to minimize the overall costs of HVAC installations.

It might be advantageous if estimating the heat transfer considers heat sources and/or heat sinks being located in the airflow path and not being part of the HVAC system. For example, a closed room including an electrical device such as a computer, might be arranged between a first air duct and a second air duct, in a way that the first air duct, the room and the second air duct are forming a portion part of the air flow path. This electrical device typically generates heat due to the electrical losses and heats up the air flowing through the air flow path and thus serves as heat source. For determining the efficiency of the HVAC system, the consideration of such heat sources or heat sinks not belonging to the HVAC system may be advantageous, as this may improve the accuracy. It may be in particular advantageous to consider them when the estimated heat transfer is used for invoicing respectively billing the energy consumption.

In another preferred embodiment, the plurality of directly measured parameters comprises differential pressure over a fan forcing the air through the air path, and wherein the air flow rate is estimated based on the differential pressure over the fan. By using the differential pressure over the fan for estimating the air flow rate an arrangement of flow sensors in the air flow path can be avoided. It is further not required to arrange flow restricting orifices, to cause a measurable differential pressure as the fan itself generates the differential pressure. The differential pressure can be measured via a differential pressure sensor or two single pressure sensors. One of the pressure values can also be obtained from another source, e.g. from the internet.

Further, it is preferred that air flow rate is estimated based on an energy consumption of the fan forcing the air through the air flow path. The determination of the energy consumption respectively of the electrical power consumed by the fan is very robust. It may be determined e.g. by measuring the motor current.

It is further preferred to estimate the air flow based on the speed of the fan forcing the air through the air flow path. The speed of the fan can be determined by different methods known by the skilled person. The speed or frequency of the fan can for instance be determined by means of a frequency or speed sensor, by using control signals such as a speed reference signal, or by evaluating the current and/or voltage applied to the electrical motor of the fan.

It is further preferred, that flow rate of the air in the air flow path is estimated based on an assumption that the flow rate is constant. Namely, if the fluctuation of the flow rate is low, e.g. less than 20, 10, 5, 2 or 1%, then the flow rate may be considered as constant. It is however required to determine an initial value of the flow rate of the air. This initial value may for instance be obtained by measuring the air flow rate with an auxiliary flow rate sensor during commissioning, by using the energy consumption of a fan respectively the speed of the fan during start up, or even before commissioning of the HVAC system by means of calculations or numerical simulations. The estimation of the air flow rate can also consider a change of the position of a damper and/or a change of the speed/frequency of the fan in the air flow path.

In a particularly preferred embodiment, the inventive method comprises estimating the energy flow in the HVAC system, based on the conditioned air humidity and the supply air humidity. By also considering the humidity of the air, the energy flow can be estimated more precisely.

In some preferred embodiments, the energy transferred from the cooling coil to the air flow is estimated by determining a relationship between the energy transferred from the cooling coil to the air flow, enthalpy of the air at the air-side, enthalpy of the conditioned air, and the air flow. It particularly preferred that the enthalpy is derived as a function of temperature and humidity. Namely, it is preferred estimating the energy flow in the HVAC system, based on the conditioned air humidity, the supply air humidity. Such estimation utilizes sensors in a particular arrangement, which helps to minimize costs and impacts on fluid lines. By considering the change of enthalpy, the contribution of a humidifier to the energy flow can be taken account.

In another preferred embodiment one of the one or more indirectly measured parameters correspond to the flow rate of the heat transfer medium. It is particularly advantageous to estimate the flow rate of the heat transfer medium based on the energy consumption of a pump in the primary flow path. It is further preferred to estimate the flow rate based on the speed respectively the frequency of the pump. The energy consumption of the pump and the speed or frequency of the pump can be determined in a similar way as the energy consumption respectively the speed or frequency of the fan. Eliminating a flow sensor in the primary flow path minimizes costs and does not negatively affect the flow of the heat transfer medium in the primary flow path.

It is particularly preferred, that flow rate of the heat transfer medium is estimated based on an assumption that the flow rate is constant. Namely, if the fluctuation of the flow rate of the heat transfer medium is low, e.g. less than 20, 10, 5, 2 or 1%, the flow rate may be considered as constant. It is however required to determine an initial value of the flow rate of the heat transfer medium. The initial value may for instance be obtained by measuring the flow rate of the heat transfer medium with an auxiliary flow rate sensor during commissioning, by using the energy consumption of a pump respectively the speed of the pump during start up of the HVAC system or also by means of calculations or numerical simulations even before commissioning. The estimation of the flow rate can also consider a change of the position of a control valve and/or a change of the speed/frequency of the pump in the in the primary flow path.

It is further preferred, that monitoring the energy flow comprises estimating the energy flow by means of the inlet temperature, the outlet temperature and the flow rate of the heat transfer medium. These parameters typically can be determined more accurately in the primary path, as the heat transfer medium has a lower flow rate and is more homogenous distributed over a section of the flow path, as the heat transfer medium, in particular water, has typically a significantly higher thermal capacity and higher thermal conductivity than air.

In another preferred embodiment determining the one or more indirectly measured parameters comprises estimating the conditioned air temperature, based on the supply air temperature, the airflow rate, the inlet temperature, the outlet temperature and the flow rate of the heat transfer medium.

Further, in a preferred embodiment, determining the one or more indirectly measured parameters comprises estimating the temperature of the conditioned air, based on energy consumption of a pump at the primary flow path, the inlet temperature, and the outlet temperature.

Further, it is an objective of some embodiments to estimate operational cost of the HVAC system, based on the monitored operating parameters of the HVAC system (for example, the energy flow) of the HVAC system. The operational costs may for instance be used for billing the energy costs of tenants obtaining conditioned air from a centralized air conditioning system, by estimating the amount of consumed energy by each tenant, respectively by the rooms or zone receiving the conditioned air. The energy consumed by a tenant of a room can be, for instance, determined by knowing the supply air temperature, the conditioned air temperature respectively the room temperature and the flow rate of the air flowing into the room.

It is particularly preferred that the energy consumption of the fan in the air flow path and/or the pump in the primary flow path are considered to calculate the operational costs of the HVAC system. It is further preferred, that the energy consumption of the fan in the air flow path and/or the pump in the primary flow path are compared to the monitored energy flow in order to determine the efficiency of the HVAC system.

Considering also the energy consumption of the fan and/or the pump does not only allow to estimate the operational costs more accurately and therefore to achieve a fairer billing, it also allows to determine the efficiency of the HVAC system more accurately.

In another embodiment of the invention, one parameter of the plurality of directly measured parameters represents the supply air temperature, wherein the supply air temperature is obtained from a sensor arranged outside of the air flow path wherein the sensor measures outside air temperature.

Additionally or alternatively, some embodiments are based on an objective of optimizing the energy flow in the HVAC system by generating a control signal for an actuator of the HVAC system. The control signal is generated based on one or more energy flow requirements comprising a desired conditioned air temperature, a desired conditioned air humidity, a desired supply air temperature, a desired supply air humidity, and thermal comfort of an occupant. According to some embodiments, the one or more energy flow requirements are obtained from one or more of an input device or a weather station.

In addition to the method for operating the HVAC system, the present invention relates to an apparatus for operating an HVAC system, in which a heat exchanger is connected to a primary flow path for a heat transfer medium, and wherein the heat exchanger is configured to transmit heat between the heat transfer medium and the air flowing through an air flow path, the apparatus comprising: means for obtaining a plurality of directly measured parameters from one or more data sources; means for determining one or more indirectly measured parameters based on the plurality of directly measured parameters; and means for monitoring energy flow of the HVAC system, based on the plurality of directly measured parameters and the one or more indirectly measured parameters, wherein the energy flow corresponds to heat transfer between the heat transfer medium and the air.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The present invention will be explained in more detail, by way of example, with reference to the drawings in which:

FIG. 1A: shows a schematic diagram illustrating heat exchange in a system according to the present invention.

FIG. 1B: shows a block diagram of a monitoring system, according to an embodiment of the present invention.

FIG. 2: shows a schematic block diagram illustrating an exemplary sequence of steps for estimation of energy transferred from cooling coil to air flow using indirect measured parameter, according to an embodiment of the present invention.

FIG. 3: shows a schematic block diagram illustrating an exemplary sequence of steps for estimation of efficiency of energy consumption, according to an embodiment of the present invention.

FIG. 4: shows a schematic diagram illustrating an arrangement of a heat exchanger unit with sensors to determine indirectly measured parameter that corresponds to temperature of conditioned air, according to an embodiment of the present invention.

FIG. 5: shows a schematic illustrating controlling of actuators of the HVAC system, based on one or more energy flow requirements, to optimize the energy flow in the HVAC system, according to an embodiment of the present invention.

FIG. 6: shows a block diagram of a method for operating the HVAC system, according to an embodiment of the present invention.

### DETAILED DESCRIPTION OF THE INVENTION

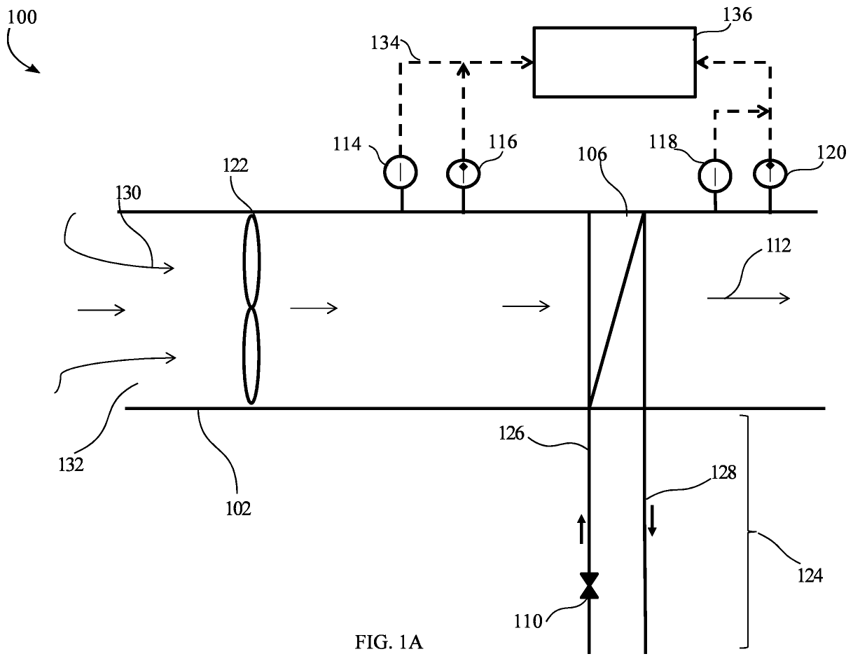

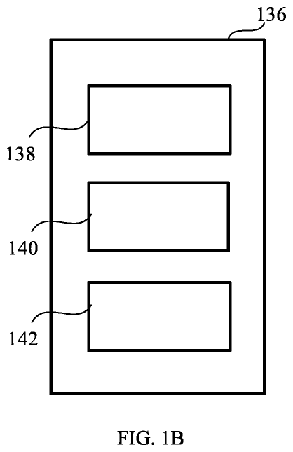

FIG. 1A shows a schematic diagram illustrating heat exchange in a system 100 according to the present invention. The system 100 comprises an air fluid line 102 respectively an air flow path for guiding air 130, a water fluid line 124 respectively a primary flow path for guiding water and a heat exchanger 106. The system 100 forms a portion of a heating, ventilating and air-conditioning (HVAC) system. The heat exchanger 106 is connected to the primary flow path with a supply line 126 and a return line 128. The air fluid line 102 and the water fluid line 124 are connected to the heat exchanger 106, wherein thermal energy is exchanged between the air and the water. The air fluid line 102 is provided with an inlet section 132. Through the inlet section 132 of the air fluid line 102 outside air is drawn into the air fluid line 102. The outside air is also referred to as fresh air. In some embodiments, a part of return air is mixed with the fresh air at the inlet section 132 and, subsequently, guided by the air fluid line 102.

The air fluid line 102 encompasses a fan 122 which moves a quantity of air 130 by adding sufficient energy to an air stream to start motion and overcome resistance to flow. The fan is preferably arranged in the air flow path upstream to the heat exchanger. The energy consumption of the fan 122 depends on volume of air moved per unit time, the efficiency of the fan 122 and its drive (not shown). The pressure difference across the fan is also a function of the volume of air moved per time and is specific to design of the fan respectively its installation in the fluid line. In context of present invention the term fan shall also encompass blowers. The water fluid line 124 encompasses a pump which is used to circulate the water in the water fluid line 124 and heat exchanger 106. In some embodiments, the water fluid line 124 circulates any suitable coolant (for example, a water-glycol mixture or glycol) in place of the water. The coolant may be referred to as a heat transfer medium. Subsequently, thermal energy is exchanged between the coolant and the air.

The fan 122 and the pump may be driven by motors, in particular by brushless EC-motors, or drives. The pump and the fan 122 may comprise drives in any number and form required for driving the pump or the fan 122. The drives may comprise motors, gears and transmission devices for driving the pump or the fan 122. In some embodiments, the system 100 may comprise a plurality of pumps and a plurality of fans. The pump or the fan 122 and/or the drives may be provided with meters for measuring one or more operational parameters of the pump and/or the fan 122, such as a frequency, current, voltage, electrical power, pressure, position or the like. In some embodiments, from the aforementioned one or more operational parameters, energy consumption of the fan 122 and/or the pump may be determined.

The water fluid line 124 carrying the water, particularly, in the heat exchanger 106 is referred to as cooling coil. To vary the quantity of water flowing through the cooling coil, a control valve 110 is provided. The water enters the heat exchanger 106 through the supply line 126 with an inlet temperature and exits the heat exchanger with an outlet temperature via the return line 128. The water flowing through the cooling coil is colder than the air passing over the cooling coil of the heat exchanger 106. Heat energy flows from a higher-temperature substance to a lower-temperature substance. Since the water flowing through the cooling coil is colder than the air passing over the cooling coil, the water in the cooling coil absorbs the heat from the air passing over it, thereby producing conditioned air 112 having a conditioned air temperature and a conditioned air humidity. Further, the conditioned air 112 is supplied to one or more rooms through an arrangement of ducts. Conversely, in some embodiments, warm air may be produced by the heat transfer in which the heat is added to the air.

The system 100 further comprises a plurality of sensors disposed at air side and water side. In the context of the present invention, the primary flow path is designated as the waterside, though other fluids than water might be used as the heat transfer medium in the primary flow path. Likewise, the air flow path is designated as the airside. According to some embodiments, the plurality of sensors may include temperature sensors, pressure sensors, in particular differential pressure sensors, and humidity sensors. The air side is provided with a temperature sensor 114 and a humidity sensor 116 upstream to the heat exchanger 106. Likewise, the air side is provided with a temperature sensor 118 and a humidity sensor 120 downstream to the heat exchanger 106. Additionally or alternatively, the pressure sensors may be provided upstream and downstream of the fan 122 at the air side in order measure the differential pressure across the fan. It might be also sufficient to measure the pressure only upstream of downstream of the fan. The temperature sensor 114 and the humidity sensor 116 may be at least partially placed within or connected to the air fluid line 102 in such a way that the temperature and humidity of air at the air-side may be measured, respectively. Likewise, the temperature sensor 118 and the humidity sensor 120 may be at least partially placed within or connected to the air fluid line 102 in such a way that the temperature and humidity of the conditioned air 112 air may be measured. The measurements from the plurality of sensors 114, 116, 118, and 120 are referred to as directly measured parameters. According to some embodiments, the plurality of sensors may be located on an energy-related envelope boundary of the heat exchanger 106 or at least in the vicinity of the envelope boundary such that the temperature and the humidity of the air at the air-side, and the temperature and humidity of the conditioned air 112 may be measured with a substantial accuracy. The envelope boundary may comprise any kind of walls, isolation or the like. The envelope boundary separates the heat exchanger 106 as a thermodynamic system from an environment surrounding it.

The system 100 further comprises data transmission lines 134 for transmitting data and/or information between the plurality of sensors 114, 116, 118, and 120, and a monitoring system 136. FIG. 1B shows a block diagram of the monitoring system 136, according to an embodiment of the present invention. The monitoring system 136 may comprise a processor 138, a memory 140 and a communication interface 142. The processor 138, the memory 140 and the communication interface 142 may be communicatively coupled to each other. The processor 138 may be a single core processor, a multi-core processor, a graphics processing unit (GPU), a computing cluster, or any number of other configurations.

The data transmission lines 134 may comprise any kind of wired or wireless connections allowing for exchanging analogue and/or digital information between all sensors shown in FIGS. 1A & 4, the drives or the motors, the meters and the monitoring system 136 with its processor 138. The monitoring system 136 may comprise interfaces and converters for conditioning data received over the transmission lines when carrying out instructions. The instructions may be stored in a memory 140. Further, the memory 140 may be configured to store information, data, content, applications, instructions, or the like, for enabling the monitoring system 136 to carry out various functions in accordance with an example embodiment of the present invention. The memory 140 may be any kind of volatile and non-volatile storage means, which may be built into the monitoring system 136, may be accessed by a computer through a public or private network, and/or maybe a portable storage medium such as a portable flash storage, optical data carrier, magnetic data carrier, or the like. The instructions may correspond to computer program code that may be structured differently and that the order of at least some of the steps could be altered, without deviating from the scope of the invention. For example, at least some of the functions and operations described below can be implemented and performed by the monitoring system 136. The communication interface 142 may comprise input interface and output interface for supporting communications to and from the all sensors shown in FIGS. 1A & 4 or described in reference thereto, and the HVAC system. The communication interface 142 may be any means such as a device or circuitry embodied in either hardware or a combination of hardware and software.

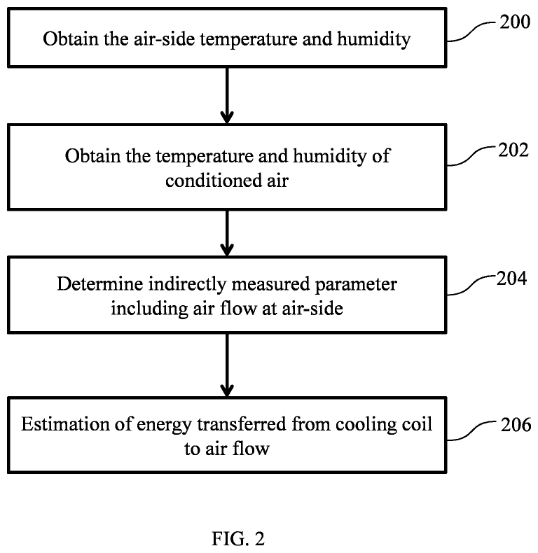

FIG. 2 shows a schematic block diagram illustrating an exemplary sequence of steps 200-206 for estimation of energy transferred from the cooling coil to air flow using indirect measured parameter, according to an embodiment of the present invention. In the first step 200, the air-side temperature and humidity are obtained from the temperature sensor 114 and the humidity sensor 116, respectively. In some embodiments, the air-side temperature and humidity are determined from weather data. The weather data is obtained, via internet, from a meteorological agency such as national weather service, weather station and the like. Further, the weather data is associated with time stamps that include one or more of time, date, season or combination thereof. The air-side temperature and humidity that are determined from the weather data are also referred to as the directly measured parameters. In step 204, the temperature and humidity of the conditioned air 112 are obtained from the temperature sensor 118 and the humidity sensor 120, which are arranged at the air duct respectively at the air fluid line downstream to the heat exchanger 106, respectively.

In step 204, an indirectly measured parameter is determined. According to some embodiments, the indirectly measured parameter corresponds to air flow ϕ_{L} at the air-side 104. In some embodiments, the air flow ϕ_{L} at the air-side 104 is estimated based on energy consumption of the fan 122, e.g. be measuring the motor current. In some other embodiments, the air flow ϕ_{L} at the air-side 104 is estimated based on a speed respectively the frequency of the fan 122. In yet some other embodiments, the air flow ϕ_{L} is estimated by measuring the differential pressure across the fan 122. For a specific fan the relation between the air flow (rate) and the differential pressure respectively between the air flow (rate) and the fan speed can be determined, e.g. by means of calibration results using flow sensors on site, by using measurement and/or simulation results which have been determined before installation on site. Usually manufacturer of fans also provides such results respectively. Respective look-up tables or polynomials linking the flow rate to the speed of the fan, the energy consumption of the fan and/or the differential air pressure can be stored in the memory 140 of the monitoring system 136. Since the air flow ϕ_{L} is estimated without any airflow sensor/meter, it is referred to as the indirectly measured parameter.

Further, based on the indirectly measured parameter (the air flow ϕ_{L}), the air-side temperature and humidity, and the temperature and humidity of the conditioned air, the energy transferred from the cooling coil to the air flow in the heat exchanger 106 may be estimated.

In the step 204, the energy transferred from the cooling coil to the air flow in the heat exchanger 106 is estimated. In the context of this invention, the energy transferred from the cooling coil to the air flow is referred to as energy flow in the HVAC system. According to one embodiment, a relationship between the energy transferred from the cooling coil to the air flow, the temperature of the air upstream to the heat exchanger 106, the temperature of the conditioned air 112, and the air flow ϕ_{L} is established, which is given by

E∝ϕ_{L}(T2−T1), (1)

where E is the energy transferred from the cooling coil to the air flow, T2 is the temperature of the conditioned air and T1 is the temperature of the air upstream to the heat exchanger 106 Thereby, from (1) the energy transferred from the cooling coil to the air flow is estimated.

In another embodiment, the energy transferred from the cooling coil to the air flow is estimated by determining a relationship between the energy transferred from the cooling coil to the air flow, enthalpy of the air upstream to the heat exchanger 106, enthalpy of the conditioned air 112, and the air flow ϕ_{L}. The relationship is given by

E∝ϕ_{L}(H2−H1), (2)

where E is the energy transferred from the cooling coil to the air flow, H2 is the enthalpy of the conditioned air and H1 is the enthalpy of the air upstream to the heat exchanger 106. In an embodiment, the enthalpy is derived as a function of temperature and humidity. Therefore, the enthalpy of the conditioned air H2 is a function of the temperature and humidity of the conditioned air 112. Likewise, the enthalpy of the air upstream to the heat exchanger H1 is a function of the temperature and humidity of the air upstream to the heat exchanger 106.

To that end, it may be realized that the energy transferred from the cooling coil to the air flow is estimated based on the directly measured parameters (T2, T1) and the indirectly measured parameter (ϕ_{L}). In other words, the energy transferred from the cooling coil to the air flow is estimated with reduced number of sensors, thereby, minimizing the overall costs of HVAC installations. Furthermore, as the number of sensors in the fluid lines (for example, the air flow path and the primary flow path) may be reduced, this in turn reduces the impact of the sensors on the fluid lines and/or flow characteristics of the fluid in the fluid lines. Additionally or alternatively, based on the energy transferred from the cooling coil to the air and the airflow, the energy provided to a room (e.g. a shop in a shopping hall) can be determined and be utilized for billing costs for the room. Additionally, in some embodiments, the estimated energy transferred is utilized for estimation of efficiency of energy consumption. It is further to be mentioned that estimation of the heat transfer between the heat transfer medium and the air can be improved by considering heat sources and/or heat sinks located in the air flow path and not being part of the HVAC system. Namely, heat sources, such as computers, any working equipment not being part of the HVAC system, may be arranged in in the air flow path. Namely, also a room comprising the heat exchanger may be part of the air flow path. The heat exchanger can for instance be a radiator, a floor heating, a chilled ceiling etc. Such a room may also comprise heat sources or heat sinks, which add heat to the airflow or remove heat from the air flow. As they are not part of the HVAC system, it might be advantageous if there contribution to the energy flow is not accounted for. Namely, in case of a heating system, a consumer should not be charged for the part of energy that is added by the consumer's devices, e.g. personal computers. However, in case the consumer's devices add heat to an air flow which has to be chilled, it may be fair that the consumer is charged for the heat the consumer generates, as the HVAC system needs to extract this heat additionally from the air flow.

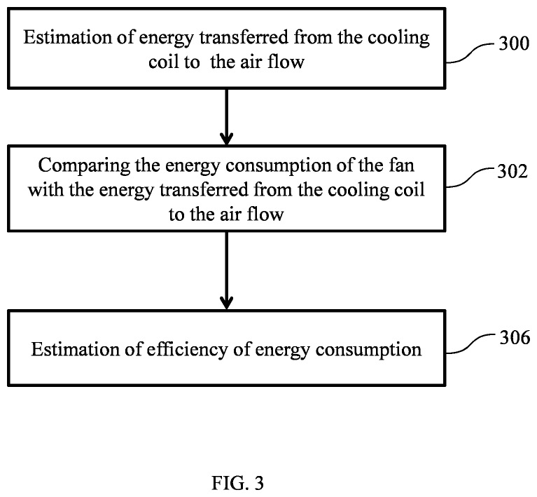

FIG. 3 shows a schematic block diagram illustrating an exemplary sequence of steps 300-306 for estimation of efficiency of energy consumption, according to an embodiment of the present invention. At step 300, in some embodiments, the energy transferred by the cooling coil from the water flow to the air flow is estimated by using two temperature sensors on the water side 124 with an assumption that the water flow is at least constant for certain time intervals. One of a temperature sensor of the two temperature sensors on the water side 124 is at the water fluid line upstream to the heat exchanger 106 and other is at the water fluid line downstream to the heat exchanger 106. The energy transferred is given by the heat flow between the water on the water side and the air on the air side. In some other embodiments, the energy transferred by the cooling coil to the air flow is estimated by using two temperature sensors on the air side with an assumption that the air flow rate is at least constant for certain time intervals. One of a temperature sensor of the two temperature sensors on the air side is at the air fluid line upstream to the heat exchanger 106 and other is at the air fluid line downstream to the heat exchanger 106. According to basic physical principles (see for example document U.S. Pat. No. 4,440,507) the heat flow dQ/dt can be determined using the following equation:

$$dQ / dt = \dot{Q} = ρ \cdot C \cdot \dot{V} ( T 1 - T 2 ) = ρ \cdot C \frac{dV}{dt} Δ T \qquad ( 1 )$$

In step 302, the energy consumption of the fan is compared with the energy transferred from the cooling coil to the air flow, respective the energy consumption of the fan is used to estimate the efficiency of the HVAC system:

$$μ \approx \frac{E}{E + {E}_{Fan}} ,$$

wherein E is the energy flow and E_{Fan} is the energy consumption of the fan.

In another embodiment, the energy consumption of the pump is compared with the energy transferred from the cooling coil to the air flow, respective the energy consumption of the pump is used to estimate the energy efficiency of the HVAC system:

$$μ \approx \frac{E}{E + {E}_{Pump}} ,$$

wherein E is the energy flow and E_{Pump} is the energy consumption of the pump.

Based on the aforementioned comparison in step 302, in step 304, the efficiency of energy consumption may be estimated. Further, the estimated efficiency of energy consumption may be utilized to optimize the energy flow of the HVAC system. Certainly, also both, the energy consumption of the fan and the energy consumption of the pump can be used simultaneously to estimate the energy efficiency of the HVAC system and/or to optimize the energy flow of the HVAC system.

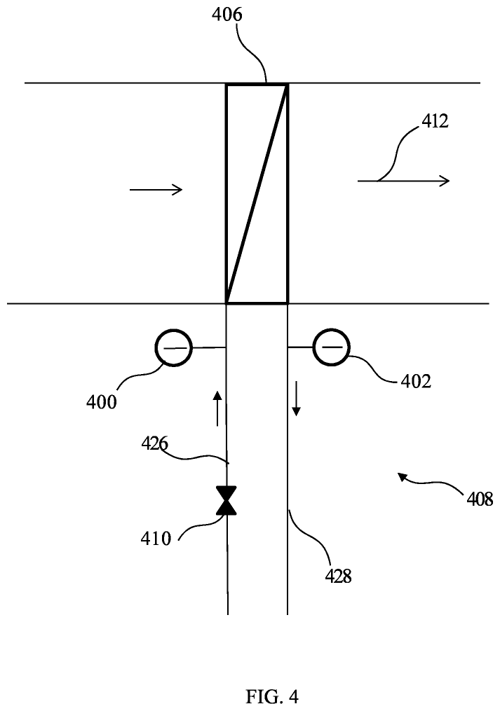

FIG. 4 shows a schematic diagram illustrating an arrangement of the heat exchanger unit 406 with sensors 400, 402 to determine indirectly measured parameter that corresponds to temperature of the conditioned air, according to an embodiment of the present invention. The temperature sensors 400, 402 are provided at the water-side 408. The temperature sensor 400 is placed at the supply line 426 of the primary flow path to measure the temperature of water entering the heat exchanger 406 i.e. the inlet temperature T_{W}_{ᵢₙ}. Similarly, the temperature sensor 402 is placed at the return line 428 of the primary flow path to measure the temperature of the water leaving the heat exchanger 406 i.e. the outlet temperature T_{W}_{ₒᵤₜ} According to some embodiments, the temperature sensor 400 and the temperature sensor 402 may be at least partially placed within or connected to the water fluid line 408 in such a way that the temperature of water entering and leaving the heat exchanger 406 may be measured, respectively.

The pump 410 provided at the water-side 408 circulates the water, resulting in water-flow ϕ_{w} in the water-fluid line. According to some embodiments, the water-flow ϕ_{w} may be determined based on the energy consumption of the pump. In some embodiments, the water-flow ϕ_{w} may be assumed as constant. The temperatures T_{W}_{ᵢₙ} and T_{W}_{ₒᵤₜ}, are obtained from the temperature sensors 400 and 402, respectively. Further, based on T1, T_{W}_{ᵢₙ}, T_{W}_{ₒᵤₜ}, and the water-flow ϕ_{w} (assumed as constant), the temperature of the conditioned air T2 may be estimated. As the temperature of the conditioned air T2 is estimated without any direct sensor measurements at the conditioned air 412, the estimated temperature of the conditioned air T2 corresponds to the indirectly measured parameter.

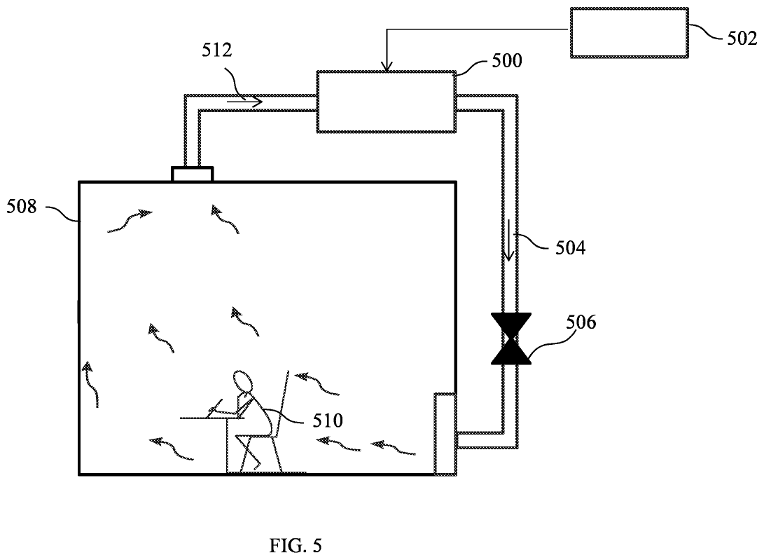

FIG. 5 shows a schematic diagram illustrating controlling of actuators of an HVAC system, based on energy flow requirements, to optimize the energy flow in the HVAC system, according to an embodiment of the present invention. The HVAC system includes an air handling unit 500 that receives return air 512 from an air conditioned room, conditions the air in order to provide supply air 504, which is distributed to the air conditioned room 508. In some embodiments, a part of the return 512 air is mixed with fresh air.

The supply air 504 distribution in the conditioned room 508 is controlled by a supply air control valve 506. The air handling unit 500 is associated with an input device (not shown) and an operation controller 502 which controls the actuators of the HVAC system in accordance with the energy flow requirements.

In some embodiments, the energy flow requirements are obtained from the input device. An occupant 510 of the air conditioned room 508 may input desired temperature and humidity to the input device. The desired temperature and the humidity may correspond to the energy flow requirements. The operation controller 502 generates control signal corresponding to the input i.e. desired temperature and the humidity and submits it to the actuators. Subsequently, supply air velocity, temperature and humidity are optimized, such that the desired temperature and humidity is achieved. Consequently, thermal comfort of the occupant 510 is achieved.

Further, the energy requirements are influenced by weather conditions such as season, the time of day, and the like. Therefore, in some embodiments, the energy flow requirements are obtained from the weather data of a weather station. The weather data may provide information of outside environment temperature and humidity, outside air velocity, and the like. Based on the weather data, the actuators of the HVAC system are controlled. For example, a control signal is generated to control an actuator of a control valve to control the flow rate of water. In some embodiments, the turning on and off the pump is based on the weather data. In some other embodiments, the difference between the inlet temperature to the heat exchanger and the outlet temperature to the heat exchanger is controlled based on the weather data, for working around a defined operating point. Thereby, optimizing the energy flow in the HVAC system based on the energy requirements. In some embodiments, the optimization of the energy flow in the HVAC system may be achieved based on the estimated air flow and the energy transferred from the cooling coil to the air flow.

Further, the energy flow of the HVAC system is monitored based on the directly measured parameters and the indirectly measured parameters for billing energy consumption costs for a zone, e.g. a room. For instance, consider a building including multiple rooms where each room is to be air conditioned at different temperatures. Based on some embodiments, amount of energy provided to a specific room may be estimated and utilized to determine energy consumption for the specific room. Subsequently, based on the energy consumption of the specific room, the cost of energy consumption may be billed for respective room. Further, based on the energy consumption determination for each room, the cost of energy consumption may be billed for respective rooms. Thereby, allowing the fair allocation of the energy costs including the air distribution for different tenants of the rooms of the building.

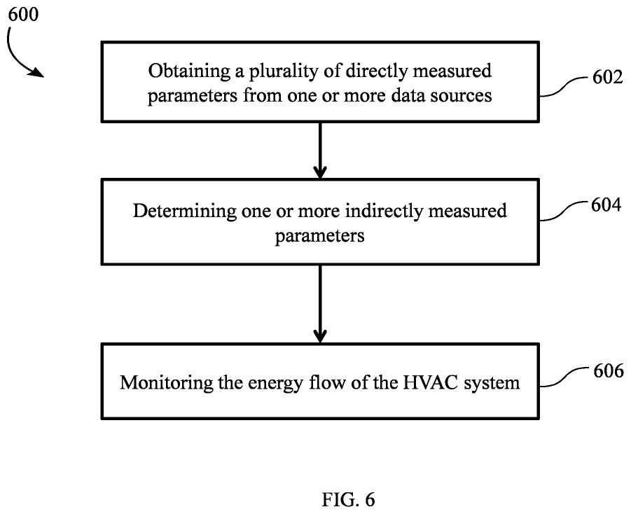

FIG. 6 shows a block diagram of a method 600 for operating the HVAC system, according to an embodiment of the present invention. It will be understood that each block of the flowchart and combination of blocks in the flowchart may be implemented by various means, such as hardware, firmware, processor, circuitry, and/or other communication devices associated with execution of software including one or more computer program instructions. Accordingly, blocks of the flowcharts support combinations of means for performing the specified functions and combinations of operations for performing the specified functions.

At block 602, the method includes obtaining the plurality of directly measured parameters from one or more data sources. In some embodiments, the one or more data sources comprise sensors disposed at the air flow path and at the primary flow path in the HVAC system, and wherein the sensors comprise a temperature sensor, a differential pressure sensor and/or a humidity sensor. Further, the plurality of directly measured parameters comprise the temperature of air at the air flow path T1, the humidity of air at the air flow path, the inlet temperature T_{W}_{ᵢₙ}, the outlet temperature T_{W}_{ₒᵤₜₜ}, and the humidity of the conditioned air.

At block 604, the method includes determining the one or more indirectly measured parameters based on one or more of the plurality of directly measured parameters. In some embodiments, the determining of the one or more indirectly measured parameters comprises estimating the air flow rate at the air flow path based on one of the energy consumption of the fan at the air flow path or a speed of the fan at the air flow path. In some other embodiments, determining the one or more indirectly measured parameters comprises estimating the temperature of the conditioned air T2, based on the supply air temperature, the airflow rate, the inlet temperature, the outlet temperature and the flow rate of the heat transfer medium

At block 606, the method includes monitoring the energy flow of the HVAC system, based on the plurality of directly measured parameters and the one or more indirectly measured parameters, wherein the energy flow corresponds to heat transfer between the heat transfer medium and the air. The method 600 further includes generating a control signal for an actuator of the HVAC system, wherein the control signal is based on one or more energy flow requirements, to optimize the energy flow in the HVAC system. The one or more energy flow requirements comprise a desired temperature of the conditioned air, a desired humidity of the conditioned air, a desired supply air temperature, a desired supply air humidity, and thermal comfort of an occupant.

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments.

Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

1. A method (600) for operating an HVAC system (100), in which a heat exchanger (106) is connected to a primary flow path (124) with a supply line (126) and a return line (128), wherein a heat transfer medium enters the heat exchanger (106) through the supply line (126) with an inlet temperature and exits the heat exchanger (106) with an outlet temperature via the return line (128), and wherein the heat exchanger (106) transmits a heat flow to air flowing through an air flow path (102), which enters the heat exchanger with a supply air temperature and a supply air humidity and which exits the heat exchanger with a conditioned air temperature and a conditioned air humidity, the method comprising:
obtaining (602) a plurality of directly measured parameters from one or more data sources;
determining (604) one or more indirectly measured parameter based on one or more of the plurality of directly measured parameters; and
monitoring (606) energy flow of the HVAC system (100), based on the plurality of directly measured parameters and the one or more indirectly measured parameters, wherein the energy flow corresponds to heat transfer between the heat transfer medium and the air.

2. The method (600) according to claim 1, wherein the one or more data sources comprise sensors (114, 116, 118, 120) disposed at the air flow path (102) and at the primary flow (124) path in the HVAC system (100), and wherein the sensors (114, 116, 118, 120) comprise a temperature sensor (114, 118), a differential pressure sensor and/or a humidity sensor (116, 120).

3. The method (600) according to claim 1, wherein one of the one or more of the indirectly measured parameters represents airflow rate of the air flowing through the air flow path (102).

4. The method (600) according to claim 1, wherein monitoring the energy flow of the HVAC system comprises estimating the heat transfer between the heat transfer medium and the air by means of the supply air temperature, the conditioned air temperature and the airflow rate of the air flowing through the air flow path (102).

5. The method (600) according to claim 4, wherein estimating the heat transfer between the heat transfer medium and the air considers heat sources and/or heat sinks located in the air flow path and not being part of the HVAC system (100).

6. The method (600) according to claim 2, wherein the plurality of directly measured parameters comprise differential pressure over a fan (122) forcing the air through the air flow path (102), and wherein the airflow rate is estimated based on the differential pressure over the fan (122).

7. The method (600) according to claim 4, wherein the air flow rate is estimated based on an energy consumption of the fan (122) forcing the air through the air flow path (102).

8. The method (600) according to claim 4, wherein the air flow rate is estimated based on the speed of the fan (122) forcing the air through the air flow path (102).

9. The method according to claim 4, wherein the flow rate of the air in the air flow path (102) is estimated based on an assumption that the flow rate is constant.

10. The method (600) according to claim 4, further comprising estimating the energy flow in the HVAC system (100), based on the conditioned air humidity and the supply air humidity.

11. The method (600) according to claim 1, wherein one of the one or more indirectly measured parameters correspond to flow rate of the heat transfer medium.

12. The method (600) according to claim 11, wherein the flow rate of the heat transfer medium is estimated based on the energy consumption of a pump in the primary flow path (124).

13. The method (600) according to claim 11, wherein the flow rate of the heat transfer medium is estimated based on an assumption that the flow rate of the heat transfer medium is constant.

14. The method (600) according to claim 1, wherein monitoring the energy flow comprises estimating the energy flow by means of the inlet temperature, the outlet temperature and the flow rate of the heat transfer medium.

15. The method (600) according to claim 1, wherein determining the one or more indirectly measured parameters comprises estimating the conditioned air temperature, based on the supply air temperature, the airflow rate, the inlet temperature, the outlet temperature and the flow rate of the heat transfer medium.

16. The method (600) according to claim 1, further comprising estimating operational cost of the HVAC system (100), based on the monitored energy flow of the HVAC system (100).

17. The method (600) according to claim 16, wherein the energy consumption of the fan (122) and/or the pump in the primary flow path are considered to calculate the operational costs of the HVAC system (100).

18. The method (600) according to claim 1, wherein the energy consumption of the fan (122) and/or the pump in the primary flow path (124) are compared to the monitored energy flow in order to determine efficiency of the HVAC system (100).

19. The method (600) according to claim 1, wherein one parameter of the plurality of directly measured parameters represents the supply air temperature, wherein the supply air temperature is obtained from a sensor arranged outside of the air flow path (102) wherein the sensor measures outside air temperature.

20. The method (600) according to claim 1, further comprising generating a control signal for an actuator of the HVAC system (100), wherein the control signal is based on one or more energy flow requirements.

21. The method (600) according to claim 20, wherein the one or more energy flow requirements comprise at least one member of a group consisting of
a. a desired conditioned air temperature,
b. a desired conditioned air humidity,
c. a desired supply air temperature,
d. a desired supply air humidity, and
e. thermal comfort of an occupant.

22. The method (600) according to claim 20, wherein the control signal is generated to optimize the energy flow in the HVAC system (100).

23. The method (600) according to claim 20, further comprising obtaining the one or more energy flow requirements from one or more of an input device or a weather station.

24. An apparatus for operating an HVAC system (100), in which a heat exchanger (106) is connected to a primary flow path (124) for a heat transfer medium, and wherein the heat exchanger (106) is configured to transmit heat between the heat transfer medium and the air flowing through an air flow path (102), the apparatus comprising:
means for obtaining (142) a plurality of directly measured parameters from one or more data sources;
means for determining (138) one or more indirectly measured parameters based on the plurality of directly measured parameters; and
means for monitoring (136, 138) energy flow of the HVAC system (100), based on the plurality of directly measured parameters and the one or more indirectly measured parameters, wherein the energy flow corresponds to heat transfer between the heat transfer medium and the air.

25. The method (600) according to claim 2, wherein one of the one or more of the indirectly measured parameters represents airflow rate of the air flowing through the air flow path (102).

26. The method (600) according to claim 2, wherein monitoring the energy flow of the HVAC system comprises estimating the heat transfer between the heat transfer medium and the air by means of the supply air temperature, the conditioned air temperature and the airflow rate of the air flowing through the air flow path (102).

27. The method (600) according to claim 3, wherein monitoring the energy flow of the HVAC system comprises estimating the heat transfer between the heat transfer medium and the air by means of the supply air temperature, the conditioned air temperature and the airflow rate of the air flowing through the air flow path (102).

28. The method (600) according to claim 3, wherein the plurality of directly measured parameters comprise differential pressure over a fan (122) forcing the air through the air flow path (102), and wherein the airflow rate is estimated based on the differential pressure over the fan (122).

29. The method (600) according to claim 4, wherein the plurality of directly measured parameters comprise differential pressure over a fan (122) forcing the air through the air flow path (102), and wherein the airflow rate is estimated based on the differential pressure over the fan (122).

30. The method (600) according to claim 5, wherein the plurality of directly measured parameters comprise differential pressure over a fan (122) forcing the air through the air flow path (102), and wherein the airflow rate is estimated based on the differential pressure over the fan (122).

31. The method (600) according to claim 5, wherein the air flow rate is estimated based on an energy consumption of the fan (122) forcing the air through the air flow path (102).

32. The method (600) according to claim 6, wherein the air flow rate is estimated based on an energy consumption of the fan (122) forcing the air through the air flow path (102).

33. The method (600) according to claim 5, wherein the air flow rate is estimated based on the speed of the fan (122) forcing the air through the air flow path (102).

34. The method (600) according to claim 6, wherein the air flow rate is estimated based on the speed of the fan (122) forcing the air through the air flow path (102).

35. The method (600) according to claim 7, wherein the air flow rate is estimated based on the speed of the fan (122) forcing the air through the air flow path (102).

36. The method according to claim 5, wherein the flow rate of the air in the air flow path (102) is estimated based on an assumption that the flow rate is constant.

37. The method according to claim 6, wherein the flow rate of the air in the air flow path (102) is estimated based on an assumption that the flow rate is constant.

38. The method according to claim 7, wherein the flow rate of the air in the air flow path (102) is estimated based on an assumption that the flow rate is constant.

39. The method according to claim 8, wherein the flow rate of the air in the air flow path (102) is estimated based on an assumption that the flow rate is constant.

40. The method (600) according to claim 5, further comprising estimating the energy flow in the HVAC system (100), based on the conditioned air humidity and the supply air humidity.

41. The method (600) according to claim 6, further comprising estimating the energy flow in the HVAC system (100), based on the conditioned air humidity and the supply air humidity.

42. The method (600) according to claim 7, further comprising estimating the energy flow in the HVAC system (100), based on the conditioned air humidity and the supply air humidity.

43. The method (600) according to claim 8, further comprising estimating the energy flow in the HVAC system (100), based on the conditioned air humidity and the supply air humidity.

44. The method (600) according to claim 9, further comprising estimating the energy flow in the HVAC system (100), based on the conditioned air humidity and the supply air humidity.

45. The method (600) according to claim 2, wherein one of the one or more indirectly measured parameters correspond to flow rate of the heat transfer medium.

46. The method (600) according to claim 3, wherein one of the one or more indirectly measured parameters correspond to flow rate of the heat transfer medium.

47. The method (600) according to claim 12, wherein the flow rate of the heat transfer medium is estimated based on an assumption that the flow rate of the heat transfer medium is constant.

48. The method (600) according to claim 2, wherein monitoring the energy flow comprises estimating the energy flow by means of the inlet temperature, the outlet temperature and the flow rate of the heat transfer medium.

49. The method (600) according to claim 3, wherein monitoring the energy flow comprises estimating the energy flow by means of the inlet temperature, the outlet temperature and the flow rate of the heat transfer medium.

50. The method (600) according to claim 11, wherein monitoring the energy flow comprises estimating the energy flow by means of the inlet temperature, the outlet temperature and the flow rate of the heat transfer medium.

51. The method (600) according to claim 2, wherein determining the one or more indirectly measured parameters comprises estimating the conditioned air temperature, based on the supply air temperature, the airflow rate, the inlet temperature, the outlet temperature and the flow rate of the heat transfer medium.

52. The method (600) according to claim 3, wherein determining the one or more indirectly measured parameters comprises estimating the conditioned air temperature, based on the supply air temperature, the airflow rate, the inlet temperature, the outlet temperature and the flow rate of the heat transfer medium.

53. The method (600) according to claim 11, wherein determining the one or more indirectly measured parameters comprises estimating the conditioned air temperature, based on the supply air temperature, the airflow rate, the inlet temperature, the outlet temperature and the flow rate of the heat transfer medium.

54. The method (600) according to claim 2, further comprising estimating operational cost of the HVAC system (100), based on the monitored energy flow of the HVAC system (100).

55. The method (600) according to claim 2, wherein the energy consumption of the fan (122) and/or the pump in the primary flow path (124) are compared to the monitored energy flow in order to determine efficiency of the HVAC system (100).

56. The method (600) according to claim 3, wherein the energy consumption of the fan (122) and/or the pump in the primary flow path (124) are compared to the monitored energy flow in order to determine efficiency of the HVAC system (100).

57. The method (600) according to claim 2, wherein one parameter of the plurality of directly measured parameters represents the supply air temperature, wherein the supply air temperature is obtained from a sensor arranged outside of the air flow path (102) wherein the sensor measures outside air temperature.

58. The method (600) according to claim 3, wherein one parameter of the plurality of directly measured parameters represents the supply air temperature, wherein the supply air temperature is obtained from a sensor arranged outside of the air flow path (102) wherein the sensor measures outside air temperature.

59. The method (600) according to claim 2, further comprising generating a control signal for an actuator of the HVAC system (100), wherein the control signal is based on one or more energy flow requirements.

60. The method (600) according to claim 3, further comprising generating a control signal for an actuator of the HVAC system (100), wherein the control signal is based on one or more energy flow requirements.

61. The method (600) according to claim 21, wherein the control signal is generated to optimize the energy flow in the HVAC system (100).

62. The method (600) according to claim 21, further comprising obtaining the one or more energy flow requirements from one or more of an input device or a weather station.

63. The method (600) according to claim 22, further comprising obtaining the one or more energy flow requirements from one or more of an input device or a weather station.
